(19) United States
(12) Patent Application Publication
(10) Pub. No.: US 2015/0154279 A1
(43) Pub. Date: Jun. 4, 2015

(54) APPARATUS AND METHOD FOR BUILDING RELATION MODEL BASED ON RESOURCE MANAGEMENT ARCHITECTURE

(71) Applicant: Electronics and Telecommunications Research Institute, Daejeon (KR)

(72) Inventors: JEU YOUNG KIM, Daejeon (KR); JI HYUN LEE, Daejeon (KR); JUN HEE PARK, Daejeon (KR)

(21) Appl. No.: 14/559,306

(22) Filed: Dec. 3, 2014

(30) Foreign Application Priority Data
Dec. 4, 2013 (KR) 10-2013-0150140
Nov. 7, 2014 (KR) 10-2014-0154661

(51) Int. Cl. G06F 17/30

(52) U.S. Cl. CPC G06F 17/30598

(57) ABSTRACT

An apparatus and method for building a relation model based on a resource management architecture. The apparatus includes: an object information generator configured to acquire information on resources existing in a network and to separate the acquired information into objects according to predetermined types of resources to generate objects and information on the objects; a data manager configured to acquire necessary data existing in the network to process and store the data; and a relation model manager configured to receive the information on the objects and the necessary data, to analyze the received information on the objects and the necessary data to generate information associated with relations between the resources, and to build a relation model based on the generated information associated with the relations.

### CROSS-REFERENCE TO RELATED APPLICATION(S)

This application claims priority from Korean Patent Application Nos. 10-2013-0150140, filed on Dec. 4, 2013, and 10-2014-0154661, filed on Nov. 7, 2014, in the Korean Intellectual Property Office, the entire disclosures of which are incorporated herein by references for all purposes.

### BACKGROUND

1. Field

The following description relates generally to an apparatus and method for building a relation model based on a resource management architecture, and more particularly to an apparatus and method for building a relation model based on a resource management architecture, which provides state awareness information by analyzing relations between resources and sensors.

2. Description of the Related Art

Recently, with the development of hardware and software technologies, various types of devices, networks, services, and the like have been introduced, and the development of a network infrastructure creates an environment where many resources communicate with each other.

In such environment, various types of information associated with network resources may be collected and analyzed.

However, in a conventional environment, there is a limitation of data that may be analyzed in addition to sensing data collected through a network, such that context has to be predicted or inferred based only on one-dimensional sensing data.

Further, such inference does not result from a clear cause-and-effect relationship, which merely enables context modeling or context prediction, and thus it is difficult to build a model as a basis of inference.

### SUMMARY

Disclosed is an apparatus and method for building a relation model for relations between resources and sensors based on a resource management architecture, in which by using operation information of a device included in network resources, relations between sensors and resources that affect the sensors may be analyzed, and results of the analysis may be processed into information to be provided for a user.

In one general aspect, there is provided an apparatus for building a relation model based on a resource management architecture, the apparatus including: an object information generator configured to acquire information on resources existing in a network and to separate the acquired information into objects according to predetermined types of resources to generate objects and information on the objects; a data manager configured to acquire necessary data existing in the network to process and store the data; and a relation model manager configured to receive the information on the objects and the necessary data, to analyze the received information on the objects and the necessary data to generate information associated with relations between the resources, and to build a relation model based on the generated information associated with the relations.

The object information generator may further include: a resource information acquirer configured to periodically acquire information associated with at least one or more resources existing in the network; a basis-relation object generator configured to separate the information associated with the relations according to the types of resources based on the acquired information to generate a basis-relation object that includes a resource objects and a relation object; and an object manager configured to provide information associated with the basis-relation object in response to a request.

In a case where a new resource is added to or deleted from the network, the object information generator may reflect the newly added or deleted resource, and separates information associated with the newly added or deleted resource into objects according to the types of resources to update the basis-relation object.

The data manager may further include: a sensing data manager configured to acquire sensing results for a specific number of sensors or a smaller number of sensors on a basis of a point in time where a sensing event occurs in a sensor, and to process and store the acquired sensing result data; a control data manager configured to acquire control history data for a specific number of devices or a smaller number of devices on a basis of a point in time where a control event occurs in a device, and to process and store the acquired control history data; and an external data manager configured to acquire external data from an external interface at a time when a request for the external data is received, and to process and store the acquired data.

The relation model manager may further include: a data retrieving component configured to retrieve and request object information of the object information generator required for analysis of relations and data of each type of the data manager, and to acquire the requested object information and data; a relation model generator configured to pattern changes in sensing data acquired by the sensor when a control event occurs in the device by using the received sensing result data and control history data, and to analyze a relation that is affected by the occurrence of the control event, to generate a relation model regarding relations between operation states of the device and changes in the sensor; and a model information manager configured to process information associated with relations between the device and the sensor based on the generated relation model to generate an instance, and to update the generated instance in response to a user's request or according to a predetermined time interval.

The relation model generator may receive information on location relations from the object information generator to reflect affecting ranges of the sensor, and may analyze usage relations to generate a relation model regarding changes of the sensor according to the operations states of the device.

In another general aspect, there is provided a method of building a relation model based on a resource management architecture, the method including: acquiring information on resources existing in a network, and separating the acquired information into objects according to predetermined types of resources, to generate objects; acquiring necessary data existing in the network to process and store the acquire data; and receiving the information on the objects and the necessary data, analyzing the received information on the objects and the necessary data to generate information associated with relations between the resources, and building a relation model based on the generated information associated with the relations.

The providing of the information on the objects in response to a request may further include: periodically acquiring information associated with at least one or more resources existing in the network; separating the information associated with the relations according to the types of resources based on the acquired information to generate a basis-relation object that includes a resource objects and a relation object; and providing information associated with the requested basis-relation object.

The providing of the information on the objects in response to a request may further include, in a case where a new resource is added to or deleted from the network, reflecting the newly added or deleted resource, and separating information associated with the newly added or deleted resource into objects according to the types of resources to update the basis-relation object.

The acquiring of the necessary data to process and store the acquired data may further include: acquiring sensing results for a specific number of sensors or a smaller number of sensors on a basis of a point in time where a sensing event occurs in a sensor, to process and store the acquired sensing result data; acquiring control history data for a specific number of devices or a smaller number of devices on a basis of a point in time where a control event occurs in a device, to process and store the acquired control history data; and acquiring external data from an external interface at a time when a request for the external data is received, to process and store the acquired data.

The building of the relation model may further include: retrieving and requesting object information of the object information generator required for analysis of relations and data of each type of the data manager, to acquire the requested object information and data; patterning changes in sensing data acquired by the sensor when a control event occurs in the device by using the received sensing result data and control history data, and analyzing a relation that is affected by the occurrence of the control event, to generate a relation model regarding relations between operation states of the device and changes in the sensor; and processing information associated with relations between the device and the sensor based on the generated relation model to generate an instance, and to update the generated instance in response to a user's request or according to a predetermined time interval.

The building of the relation model may further include receiving information on location relations from the object information generator, reflecting affecting ranges of the sensor, and analyzing usage relations, to generate a relation model regarding changes of the sensor according to the operations states of the device.

### BRIEF DESCRIPTION OF THE DRAWINGS

FIG. 1 is a diagram illustrating an environment where an apparatus for building a relation model based on a resource management architecture according to an exemplary embodiment.

FIG. 2 is a diagram illustrating an inner configuration of an apparatus for building a relation mode based on a resource management architecture according to an exemplary embodiment.

FIG. 3 is a detailed diagram illustrating an object information generator in FIG. 2 according to a first exemplary embodiment.

FIG. 4 is a detailed diagram illustrating an object information generator in FIG. 2 according to a second exemplary embodiment.

FIG. 5 is a detailed diagram illustrating a data manager in FIG. 2.

FIG. 6 is a detailed diagram illustrating a relation model manager in FIG. 2.

FIG. 7 is a diagram illustrating a structure of a relation model generated by an apparatus for building a relation model based on a resource management architecture according to an exemplary embodiment.

FIG. 8 is a diagram illustrating a relation analysis table according to an exemplary embodiment.

FIG. 9 is a diagram illustrating an instance generated according to an exemplary embodiment.

FIG. 10 is a flowchart illustrating a method of building a relation model based on a resource management architecture according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Like reference numerals in the drawings denote like elements, and thus their description will be omitted.

Unless the context clearly indicates otherwise, the terms “comprises” and/or “comprising” as used herein will be understood to mean that the list following is non-exhaustive and may or may not include any other additional suitable items, for example one or more further component(s), operation(s), procedure(s), and/or element(s) as appropriate.

Hereinafter, an apparatus and method for building a relation model based on resource management according to an exemplary embodiment will be described.

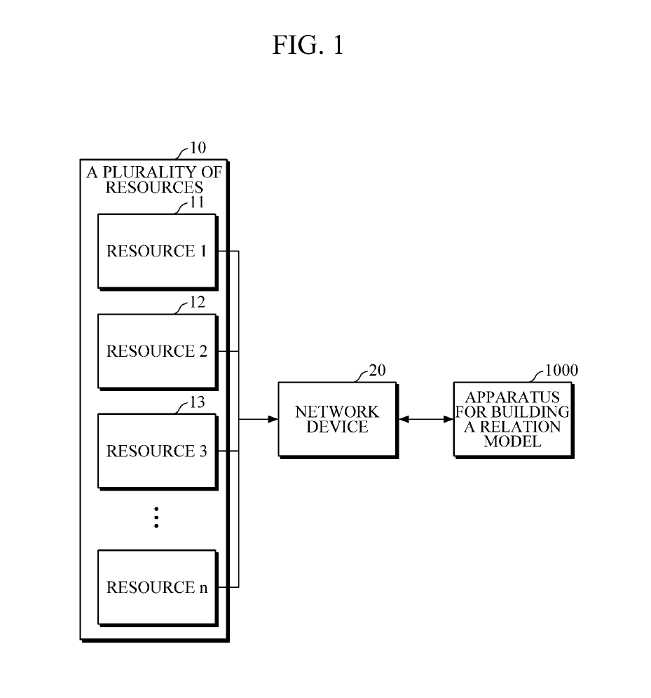

FIG. 1 is a diagram illustrating an environment where an apparatus for building a relation model based on a resource management architecture according to an exemplary embodiment.

Referring to FIG. 1, a plurality of resources 10 that include resource 1 11, resource 2 12, resource 3 13, and resource n may form a network with the apparatus 1000 for building a relation model through a network device 20, and may transmit through a network resource information to the apparatus 1000 for building a relation model.

A resource may be a device that has a physical calculation function or may be a virtual device defined to have a virtual operation function performed by a physical device.

Alternatively, a resource may include at least any one of sensors that may collect data by sensing.

Further, the network device 20 may be a device that may connect a plurality of resources with each other and may connect resources to the apparatus for building a relation model through a network.

In an exemplary embodiment, a server may be used as the network device 20, but the network device 20 is not limited thereto, and may be any device that may build a networking environment.

The plurality of resources 10 are connected with each other through the network device 20, and may also be connected to the apparatus 100 for building a relation model.

Here, resources may include a sensor that may obtain information or a device that may transmit and receive information.

Information of the plurality of resources 10 may be transmitted to the apparatus 1000 for building a relation model.

In an exemplary embodiment, as the apparatus 100 for building a relation model receives information from a sensor and a device, not only sensor information but also device information that causes changes in sensing data may be managed, thereby providing a systematic context management function.

Information received from a sensor and a device may be data collected by the sensor and the device to enable inference of a state of a network in which resources are included.

Such managed information included in resources to infer a state of a network that includes connected resources may be used as basis information for inference of a state when analyzing occurrence of a defect or an unexpected event in a network.

Further, a relation model between a device and a sensor may be established in an ontology structure, thereby enabling determination based on probability rather than definitive determination.

The network may be any wired or wireless network, such as Ethernet, Wireless Local Area Network (WLAN), RS485, Zigbee, Power Line Communication (PLC), and Bluetooth, which may be used as a local area network or a short distance network.

In an exemplary embodiment, through networking of various resources, a network device, and the apparatus 1000 for building a relation model, object information of various domains may be separated into objects in a uniform resource structure, and separated object information may be analyzed with accumulated data based on sensing information, device control information, and external environment information, to generate a relation model by detecting relations between a device included in resources and a sensor.

Relation information obtained from the relation model is implicit information, and provides information that may be used to determine system context as logical two-dimensional information beyond fragmentary one-dimensional information, thereby enabling cognitive state awareness.

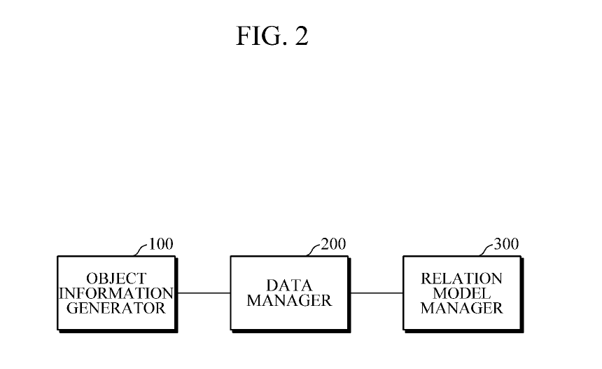

FIG. 2 is a diagram illustrating an inner configuration of an apparatus for building a relation mode based on a resource management architecture according to an exemplary embodiment.

Referring to FIG. 2, the apparatus 1000 for building a relation model based on a resource management architecture includes an object information generator 100, a data manager 200, and a relation model manager 300.

The object information generator 100 may generate objects and information on the objects by obtaining information of resources existing in a network, and by separating the obtained information into objects according to predetermined types of resources.

The object information may be information of a linked list type that is made by selecting data pre-defined by a user to be necessary for relation analysis of a plurality of objects from among generated objects.

In an exemplary embodiment, the generated object information may have a smaller data size than an object to enable more rapid and easier relation analysis of information on a plurality of objects than in a case of analysis using an object itself.

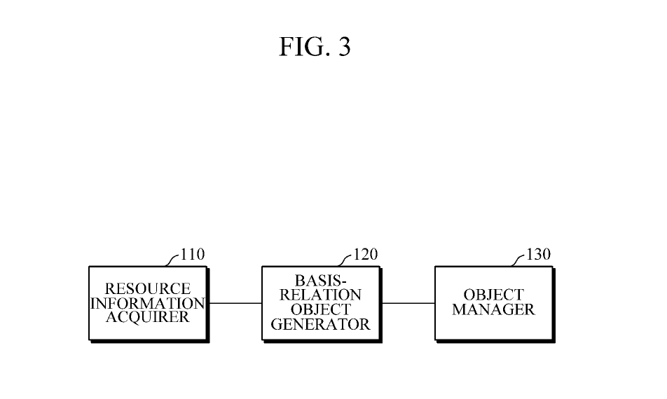

The object information generator 100 will be described in detail with reference to FIG. 3 below.

FIG. 3 is a detailed diagram illustrating an object information generator in FIG. 2 according to a first exemplary embodiment.

Referring to FIG. 3, the object information generator 100 includes a resource information acquirer 110, basis-relation object generator 120, and an object manager 130.

The resource information acquirer 110 may periodically acquire resource information associated with at least one or more resources existing in a network.

The resource information may be information on a sensor or a device as resources connected to a network. In an exemplary embodiment, the resource information may include types of resources, operation time, operation locations, operation patterns, types of information to be collected, and the like, but is not limited thereto, and may be any type of information predefined by a user.

In an exemplary embodiment, a period of obtaining resource information may be predetermined by a user, or may be determined by receiving input of information from a user.

Further, in an exemplary embodiment, in a case where a new resource is added to or deleted from periodically obtained resource information, information on a newly added or deleted resource may be transmitted to an object updater 140.

The basis-relation object generator 120 may generate a basis-relation object, which includes resource objects and relation objects, by separating the resource information into objects according to the types of resources based on the acquired information.

The basis-relation object may include resource information, which has been separated into objects, and relation information between resources in a linked list type, in which the basis-relation object may define relations of each of the resources according to separated types of resources.

Further, the basis-relation object may be a graph model that includes a source object and a relation object as entity.

The resource object may refer to objects that include various types of property information, such as names of resources to be managed, types, identities (IDs), state information, functions, and the like, of resources.

Further, the relation object may be objects that define relations between a plurality of resource objects, and may refer to objects that include relation names, types, IDs, source resource objects, and target resource objects.

The object manager 130 may provide information associated with basic relation objects in response to a request.

In an exemplary embodiment, once object information required for the relation model manager 300 to generate a relation model is requested, the object manager 130 may transmit the requested object information to the relation model manager 300, but is not limited thereto, and may transmit requested information to a user that requests object information, or to an external device connected to a network.

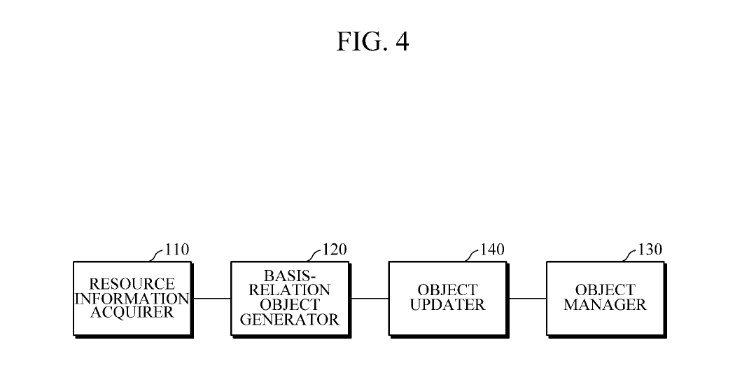

FIG. 4 is a detailed diagram illustrating an object information generator in FIG. 2 according to a second exemplary embodiment.

Referring to FIG. 4, the object information generator 100 includes a resource information acquirer 110, a basis-relation object generator 120, and an object manager 130, and may further include an object updater 140.

In a case where new resources are added to or deleted from a network, the object updater 140 reflects the newly added or deleted resources and separates information associated with the resources into objects to update basis-relation objects.

In an exemplary embodiment, information associated with the newly added or deleted resources may be provided from the resource information acquirer 110.

In an exemplary embodiment, a user may check whether new resources are added or deleted according to a predetermined period, but is not limited thereto, and may use any method of checking whether new resources are added or deleted or the like at a time desired by a user.

The data manager 200 may acquire necessary data in the network, and may process and store the acquired data.

The necessary data may be data required for analysis of relations predetermined by a user, and is not limited to a specific type of data, but may be any data that may result in correlations between resources and objects in a meaningful manner.

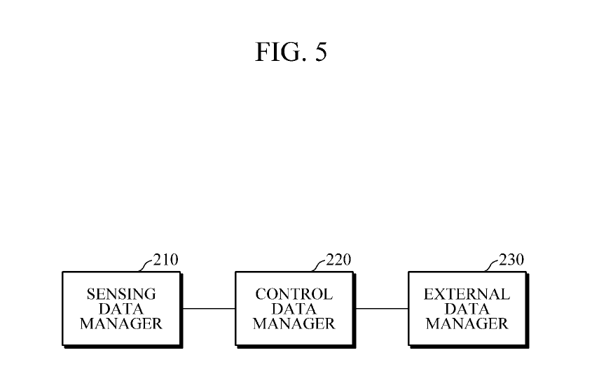

The data manager 200 will be described in detail with reference to FIG. 5 below.

FIG. 5 is a detailed diagram illustrating a data manager in FIG. 2.

Referring to FIG. 5, the data manager 200 includes a sensing data manager 210, a control data manager 220, and an external data manager 300.

The sensing data manager 210 may acquire sensing results for a specific number or a smaller number of sensors on a basis of a point in time where a sensing event occurs in a sensor, and may process and store the acquired sensing result data.

The sensing event may refer to a case where requirements of a sensor for collecting information are satisfied, and/or where the sensor receives an operation command for the collection.

The control data manager 220 may acquire control history data for a specific number or a smaller number of devices on a basis of a point in time where a control event occurs in a device, and may process and store the acquired control history data.

The control event may refer to a case where a command to control a device is received, and/or a requirement for generating a control command is satisfied.

The external data manager 300 may acquire external data from an external interface at a time when a request for the external data is received, and may process and store the acquired data.

The external data may be external data (e.g., weather, power, network, etc.) provided through an external interface (e.g., web searching, etc.).

The relation model manager 300 may receive object information and necessary data, and may analyze the received object information and necessary data to generate information associated with relations between resources, and a relation model may be established based on the generated relation information.

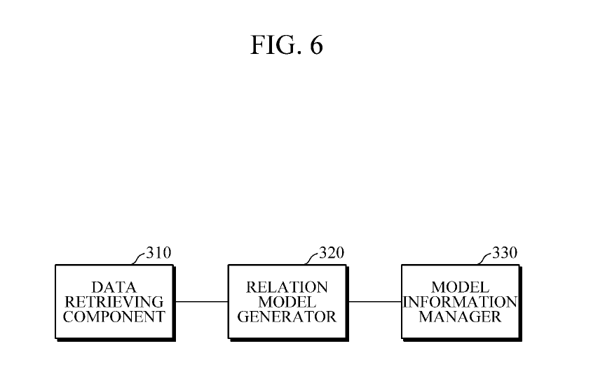

The relation model manager 300 will be described in detail with reference to FIG. 6 below.

FIG. 6 is a detailed diagram illustrating a relation model manager in FIG. 2.

Referring to FIG. 6, the relation model manager 300 includes a data retrieving component 310, a relation model generator 320, and a model information manager 330.

The data retrieving component 310 may retrieve and request object information of the object information generator 100 required for analysis of relations, and data of each type of the data manager 200, and may acquire the requested object information and data.

By using the received sensing result data and control history data, the relation model generator 320 may patterning of changes in sensing data acquired by a sensor when a control event occurs in a device.

By analyzing a relation that is affected by an occurrence of a control event based on the patterns, a relation model may be generated for operation states of a device and changes in the sensor.

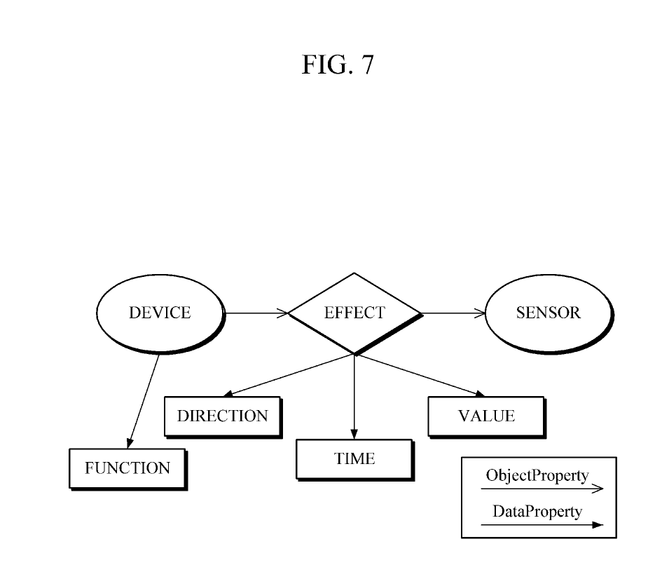

The relation model will be described in detail with reference to FIG. 7 below.

FIG. 7 is a diagram illustrating a structure of a relation model generated by an apparatus 1000 for building a relation model based on a resource management architecture according to an exemplary embodiment.

Referring to FIG. 7, a relation model based on a resource management architecture is illustrated as a schema defined in an ontology structure to represent information associated with relations between a device and a sensor.

In a basic structure of a relation model based on a resource management architecture, relations regarding a sensor that collects data associated with specific effects (e.g., direction, values, time, etc.) generated in a device for each resource are represented, and a lower level property (object property), which may include detailed information, and data property are defined to enable more detailed representation.

The object property may refer to a function added to include information on which function is operated for a component of a relation model.

Further, the data property may refer to additional indication of direction information regarding sensor changes at every time interval.

The model information manager 330 may generate an instance by processing information associated with relations between a device and a sensor based on a generated relation model, and may update the generated instance in response to a user's request, or according to a time interval predetermined by a user.

The instance may refer to elements of separate information constituting a group of relation information.

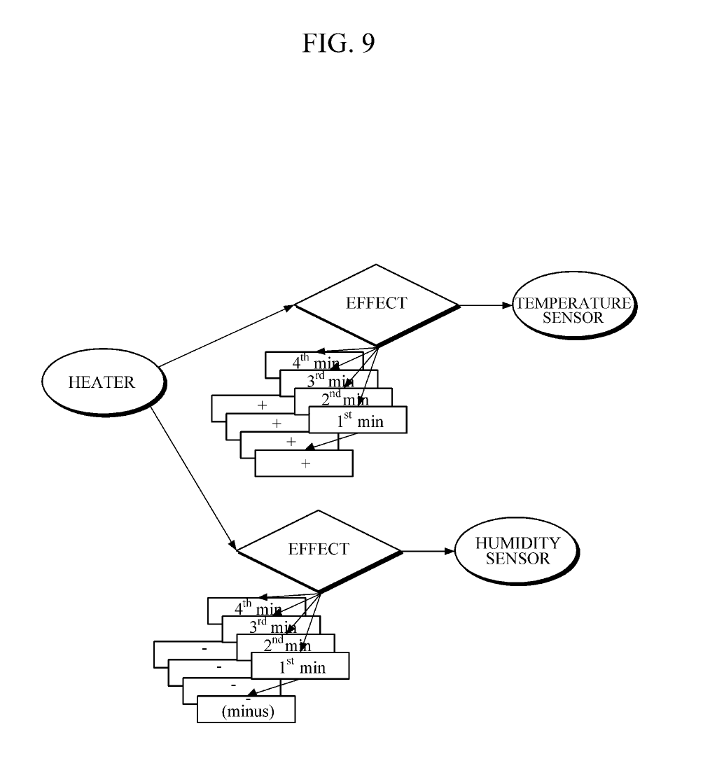

The generated instance will be described in detail with reference to FIG. 9 later.

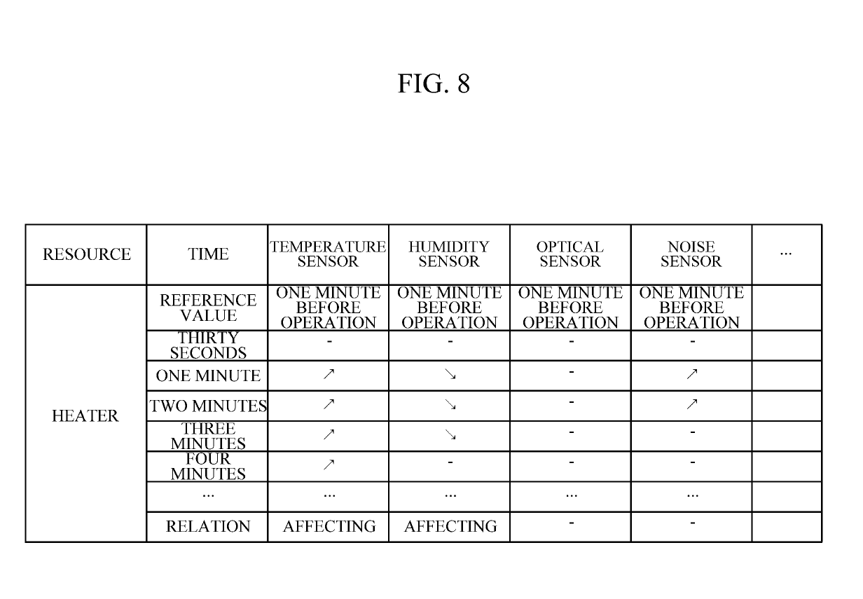

FIG. 8 is a diagram illustrating a relation analysis table according to an exemplary embodiment.

In an exemplary embodiment, the analysis of relations, which is the basis of generation of is a relation model, may be performed as follows:

Process 1: collecting received sensing data according to analysis time interval.

Process 2: calculating an average value of the data collected during the predetermined analysis time interval, and determining the calculated average value as a representative value of the analysis time.

Process 3: obtaining a standard deviation from a representative value of a previous analysis time and a representative value of a current analysis time.

Process 4: in a case where the standard deviation is lower than a predetermined threshold, the standard deviation is indicated in a negative direction, if greater than the threshold, it is indicated in a positive direction, and if the standard deviation is the same as the threshold, it is indicated as no change.

Referring to FIG. 8, in a case where a heater is selected as a target device, relation analysis is performed every minute for sensors, each of which is connected to the heater, and results of the analysis may be shown at every predetermined time interval (e.g., every thirty seconds or every minute) in a positive direction, in a negative direction, or as no change.

Further, in a case where results are shown in a positive direction or in a negative direction, it is determined that analysis is affected, such that result values may be output.

FIG. 9 is a diagram illustrating an instance generated according to an exemplary embodiment.

FIG. 9 illustrates an instance generated based on results of relation analysis according to the exemplary embodiment of FIG. 8.

By analyzing relations between sensors, each of which is connected to a heater, results of the analysis may be shown for a predetermined time interval (e.g., every thirty seconds or every minute) in three manners, including a positive direction (+), a negative direction (−), or no change.

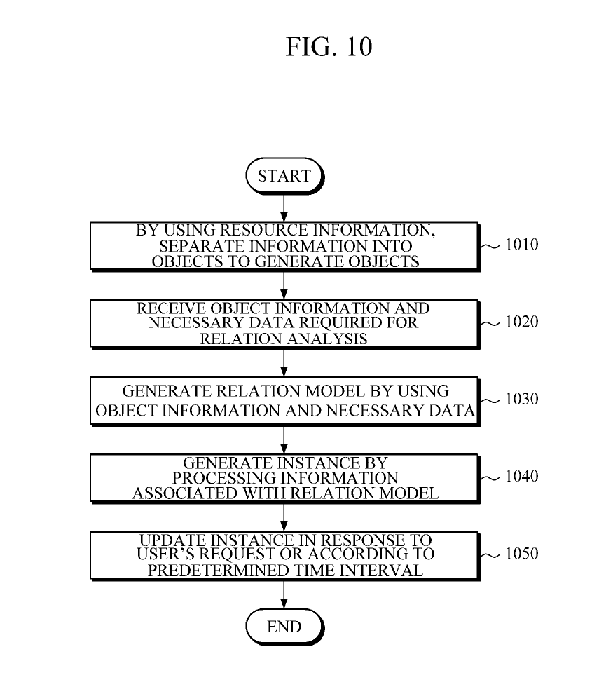

FIG. 10 is a flowchart illustrating a method of building a relation model based on a resource management architecture according to an exemplary embodiment.

By using received resource information, the information is separated into objects according to the types of resources, to generate objects in 1010.

In an exemplary embodiment, by using the received information, the resource information may be separated into objects according to the types of resources, and by analyzing relations between resources, a basis-relation object may be generated that includes resource objects and relation objects.

The basis-relation object may include resource information, which has been separated into objects, and relation information associated with relations between resources in a linked list type, in which the basis-relation object may define relations of resources according to separated types of resources.

Further, the basis-relation object may be a graph model that includes a source object and a relation object as entity.

Object information required for relation analysis and necessary data are received in 1020.

In an exemplary embodiment, the necessary data may include sensing data, control data, and external data, but the data is not limited thereto.

By using the received object information and necessary data, relations between a device and a sensor are analyzed to generate a relation model in 1030.

In an exemplary embodiment, by using sensing result data and control history data among the received object information and necessary data, changes in sensing data acquired by a sensor when a control event occurs in a device may be patterned, such that a relations that is affected by an occurrence of a control event may be analyzed to generate a relation model regarding relations between operation states of a device and changes in the sensor.

An instance is generated in 1040 by processing information associated with the generated relation model.

In an exemplary embodiment, an instance refers to elements of separate information that constitutes a group of relation information.

The generated instance is updated in 1050 in response to a user's request, or according to a predetermined time interval.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for building a relation model based on a resource management architecture, the apparatus comprising:
an object information generator configured to acquire information on resources existing in a network and to separate the acquired information into objects according to predetermined types of resources to generate objects and information on the objects;
a data manager configured to acquire necessary data existing in the network to process and store the data; and
a relation model manager configured to receive the information on the objects and the necessary data, to analyze the received information on the objects and the necessary data to generate information associated with relations between the resources, and to build a relation model based on the generated information associated with the relations.

2. The apparatus of claim 1, wherein the object information generator further comprises:
a resource information acquirer configured to periodically acquire information associated with at least one or more resources existing in the network;
a basis-relation object generator configured to separate the information associated with the relations according to the types of resources based on the acquired information to generate a basis-relation object that includes a resource objects and a relation object; and
an object manager configured to provide information associated with the basis-relation object in response to a request.

3. The apparatus of claim 2, wherein in a case where a new resource is added to or deleted from the network, the object information generator reflects the newly added or deleted resource, and separates information associated with the newly added or deleted resource into objects according to the types of resources to update the basis-relation object.

4. The apparatus of claim 1, wherein the data manager further comprises:
a sensing data manager configured to acquire sensing results for a specific number of sensors or a smaller number of sensors on a basis of a point in time where a sensing event occurs in a sensor, and to process and store the acquired sensing result data;
a control data manager configured to acquire control history data for a specific number of devices or a smaller number of devices on a basis of a point in time where a control event occurs in a device, and to process and store the acquired control history data; and
an external data manager configured to acquire external data from an external interface at a time when a request for the external data is received, and to process and store the acquired data.

5. The apparatus of claim 1, wherein the relation model manager further comprises:
a data retrieving component configured to retrieve and request object information of the object information generator required for analysis of relations and data of each type of the data manager, and to acquire the requested object information and data;
a relation model generator configured to pattern changes in sensing data acquired by the sensor when a control event occurs in the device by using the received sensing result data and control history data, and to analyze a relation that is affected by the occurrence of the control event, to generate a relation model regarding relations between operation states of the device and changes in the sensor; and
a model information manager configured to process information associated with relations between the device and the sensor based on the generated relation model to generate an instance, and to update the generated instance in response to a user's request or according to a predetermined time interval.

6. The apparatus of claim 5, wherein the relation model generator receives information on location relations from the object information generator to reflect affecting ranges of the sensor, and analyzes usage relations to generate a relation model regarding changes of the sensor according to the operations states of the device.

7. A method of building a relation model based on a resource management architecture, the method comprising:
is acquiring information on resources existing in a network, and separating the acquired information into objects according to predetermined types of resources, to generate objects;
acquiring necessary data existing in the network to process and store the acquire data; and
receiving the information on the objects and the necessary data, analyzing the received information on the objects and the necessary data to generate information associated with relations between the resources, and building a relation model based on the generated information associated with the relations.

8. The method of claim 7, wherein the providing of the information on the objects in response to a request further comprises:
periodically acquiring information associated with at least one or more resources existing in the network;
separating the information associated with the relations according to the types of resources based on the acquired information to generate a basis-relation object that includes a resource objects and a relation object; and
providing information associated with the requested basis-relation object.

9. The method of claim 8, wherein the providing of the information on the objects in response to a request further comprises, in a case where a new resource is added to or deleted from the network, reflecting the newly added or deleted resource, and separating information associated with the newly added or deleted resource into objects according to the types of resources to update the basis-relation object.

10. The method of claim 7, wherein the acquiring of the necessary data to process and store the acquired data further comprises:
acquiring sensing results for a specific number of sensors or a smaller number of sensors on a basis of a point in time where a sensing event occurs in a sensor, to process and store the acquired sensing result data;
acquiring control history data for a specific number of devices or a smaller number of devices on a basis of a point in time where a control event occurs in a device, to process and store the acquired control history data; and
acquiring external data from an external interface at a time when a request for the external data is received, to process and store the acquired data.

11. The method of claim 7, wherein the building of the relation model further comprises:
retrieving and requesting object information of the object information generator required for analysis of relations and data of each type of the data manager, to acquire the requested object information and data;
patterning changes in sensing data acquired by the sensor when a control event occurs in the device by using the received sensing result data and control history data, and analyzing a relation that is affected by the occurrence of the control event, to generate a relation model regarding relations between operation states of the device and changes in the sensor; and
processing information associated with relations between the device and the sensor based on the generated relation model to generate an instance, and to update the generated instance in response to a user's request or according to a predetermined time interval.

12. The method of claim 11, wherein the building of the relation model further comprises receiving information on location relations from the object information generator, reflecting affecting ranges of the sensor, and analyzing usage relations, to generate a relation model regarding changes of the sensor according to the operations states of the device.
